(19) United States
(12) Patent Application Publication
(10) Pub. No.: US 2013/0278606 A1
(43) Pub. Date: Oct. 24, 2013

(54) COMPUTING DEVICE AND METHOD FOR ANALYZING ASSEMBLY DEFORMATION OF PRODUCT

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); YI LIU, Shenzhen (CN)

(73) Assignees: HON HAI PRECISION INDUSTRY CO., LTD., New Taipei (TW); HONG FU JIN PRECISION INDUSTRY (ShenZhen) CO.,LTD., Shenzhen (CN)

(21) Appl. No.: 13/867,128

(22) Filed: Apr. 22, 2013

(30) Foreign Application Priority Data
Apr. 24, 2012 (CN) 2012101216235

(51) Int. Cl. G06T 11/20

(52) U.S. Cl. CPC G06T 11/20
USPC 345/441

(57) ABSTRACT

In a method for analyzing assembly deformation of a product using a computing device, the computing device loads a reference drawing of a product and an actual drawing of the product after assembly into a storage system. The actual drawing is aligned with the reference drawing. A nearest distance from each point in the actual drawing to a similar point in the reference drawing is calculated, and a range that the nearest distance falls within is determined. The computing device marks each point in the actual drawing to indicate the range that the nearest distance falls within. The marked actual drawing is displayed on a display device.

### BACKGROUND

1. Technical Field

The embodiments of the present disclosure relate to quality inspection systems and methods, and particularly to a computing device and a method for analyzing assembly deformation of a product.

2. Description of Related Art

When manufactured parts are assembled into a product, assembly stresses may cause assembly deformation of the product. Products with serious deformation may be unqualified, so assembly deformation analysis of the product is needed.

### BRIEF DESCRIPTION OF THE DRAWINGS

FIG. 1 is a block diagram of one embodiment of a computing device.

FIG. 2 is a block diagram of one embodiment of function modules of a deformation analysis system in FIG. 1.

FIG. 3 is a flowchart of one embodiment of a method for analyzing assembly deformation of a manufactured part of a product using the computing device in FIG. 1.

FIG. 4 is a flowchart of one embodiment of a method for analyzing assembly deformation of the whole product using the computing device in FIG. 1.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of a non-transitory computer-readable medium include CDs, DVDs, flash memory, and hard disk drives.

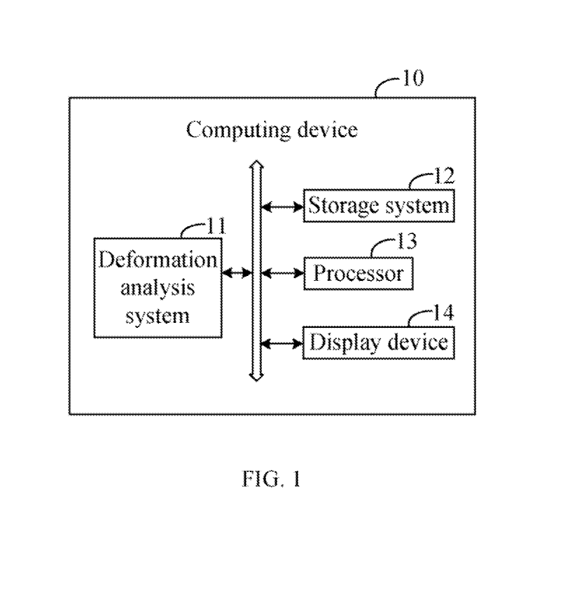

FIG. 1 is a block diagram of one embodiment of a computing device 10. In the embodiment, the computing device 10 includes a deformation analysis system 11, a storage system 12, at least one processor 13, and a display device 14. The storage system 12 stores reference drawings of a product and actual drawings of the product after assembly. The reference drawings of the product may include point clouds of manufactured parts of the product before assembly and design drawings of the product. The actual drawings of the product after assembly may include point clouds of the manufactured parts of the product after assembly and point clouds of the product after assembly. The manufactured parts (e.g. manufactured parts A, B, and C) are assembled into the product. When the manufactured parts are assembled, assembly deformation may occur. The deformation analysis system 11 analyzes the assembly deformation of the product according to an actual drawing of the product after assembly and a corresponding reference drawing of the product. The storage system 12 may be a dedicated memory, such as EPROM, a hard disk driver (HDD), or flash memory. In some embodiments, the storage system 12 may also be an external storage device, such as an external hard disk, a storage card, or other data storage medium.

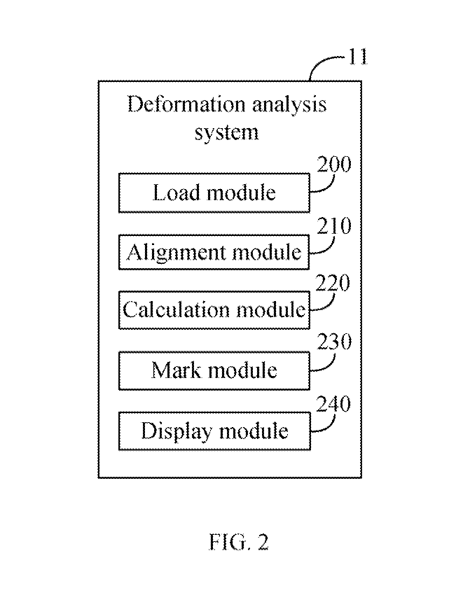

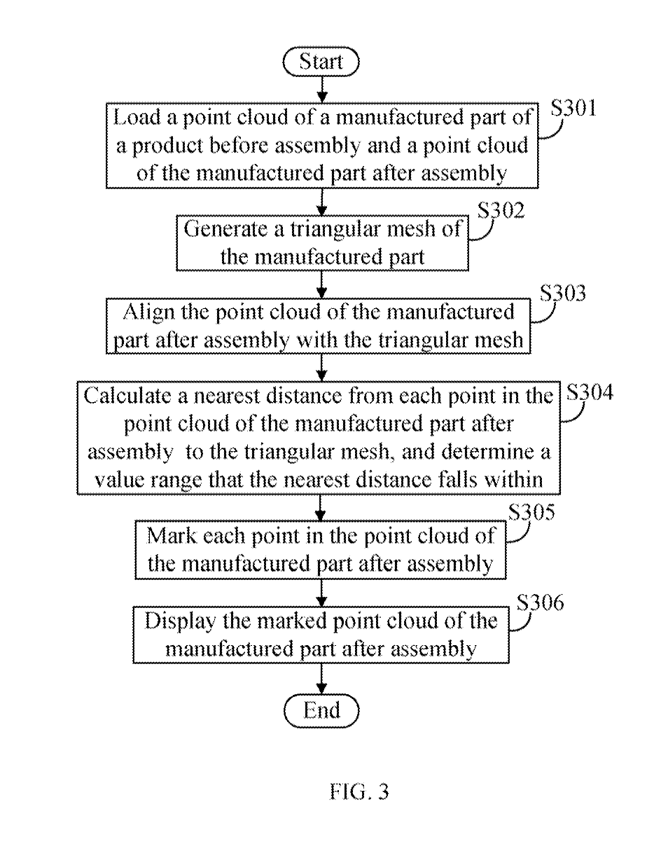

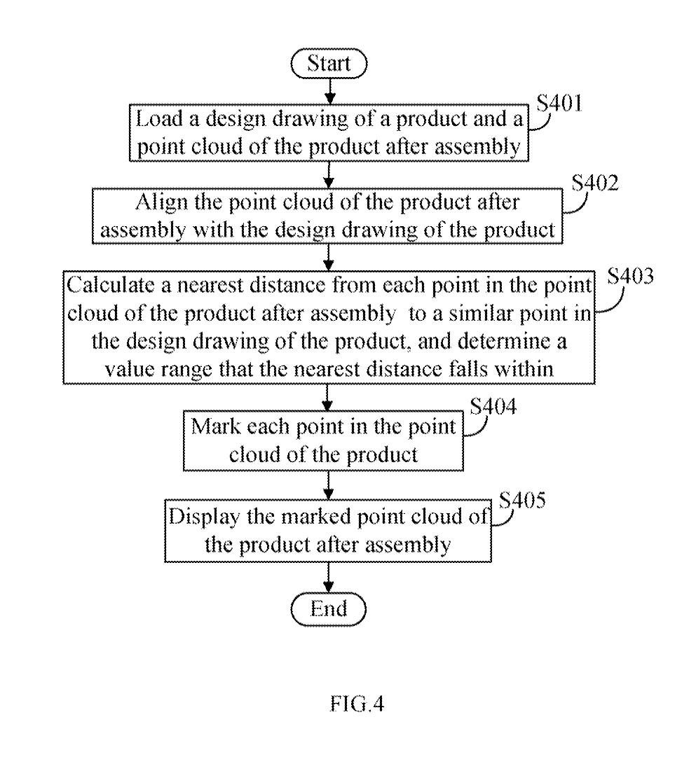

FIG. 2 is a block diagram of one embodiment of function modules of the deformation analysis system 11 in FIG. 1. The deformation analysis system 11 includes a load module 200, an alignment module 210, a calculation module 220, a mark module 230, and a display module 240. The modules 200-240 may comprise computerized code in the form of one or more programs that are stored in the storage system 12. The computerized code includes instructions that are executed by the at least one processor 13, to provide the aforementioned functions of the deformation analysis system 11. A detailed description of the functions of the modules 200-240 is given below and in reference to FIGS. 3-4.

FIG. 3 is a flowchart of one embodiment of a method for analyzing assembly deformation of a manufactured part of the product using the computing device 10 in FIG. 1. Depending on the embodiment, additional steps may be added, others removed, and the ordering of the steps may be changed.

In step S301, the load module 200 loads a point cloud of the manufactured part before assembly and a point cloud of the manufactured part after assembly into the storage system 12.

In step S302, the load module 200 generates a triangular mesh of the manufactured part according to the point cloud of the manufactured part before assembly. The triangular mesh consists of a number of contiguous triangles. A meshing method, such as an iterative algorithm or the Delaunay algorithm, may be used to generate the triangular mesh.

In step S303, the alignment module 210 aligns the point cloud of the manufactured part after assembly with the triangular mesh generated from the point cloud of the manufactured part before assembly. In one embodiment, the alignment module 210 may use a method of least squares to align the point cloud of the manufactured part after assembly with the triangular mesh. A function of the method of least squares to align the point cloud of the manufactured part after assembly with the triangular mesh may be:

$$f ( X ) = Min \sqrt{( {\sum }_{n = 1}^{n} {( \sqrt{{( X 2 - X 1 )}^{2} + {( Y 2 - Y 1 )}^{2} + {( Z 2 - Z 1 )}^{2}} )}^{2} ) \text{/} n} ,$$

where (X1, Y1, Z1) are coordinates of a point in the triangular mesh, (X2, Y2, Z2) are coordinates of a point in the point cloud of the manufactured part after assembly.

In step S304, for each point in the point cloud of the manufactured part after assembly, the calculation module 220 calculates a nearest distance from the point in the point cloud of the manufactured part after assembly to the triangular mesh, and determines a range that the nearest distance falls within. As mentioned above, the triangular mesh consists of a plurality of triangles. For a point in the point cloud of the manufactured part after assembly, the calculation module 220 calculates a distance from the point to each of the triangles, and determines a minimum distance from the point to the triangles as the nearest distance from the point to the triangular mesh. In one example, a first range (e.g., less than or equal to 0.10 mm), a second range (e.g., greater than 0.10 mm and less than or equal to 0.20 mm), and a third range (e.g., greater than 0.20 mm) are predefined.

In step S305, the mark module 230 marks each point in the point cloud of the manufactured part after assembly, to indicate the range that the nearest distance from the point in the point cloud of the manufactured part after assembly to the triangular mesh falls within. In one example, if the nearest distance from one point in the point cloud of the manufactured part after assembly to the triangular mesh is less than or equal to 0.10 mm, the point is marked with green. If the nearest distance from one point in the point cloud of the manufactured part after assembly to the triangular mesh is larger than 0.10 mm and less than or equal to 0.20 mm, the point is marked with yellow. If the nearest distance from one pint in the point cloud of the manufactured part after assembly to the triangular mesh is more than 0.20 mm, the point is marked with red.

In step S306, the display module 240 displays the marked point cloud of the manufactured part after assembly on the display device 14.

FIG. 4 is a flowchart of one embodiment of a method for analyzing assembly deformation of the whole product using the computing device 10 in FIG. 1. Depending on the embodiment, additional steps may be added, others removed, and the ordering of the steps may be changed.

In step S401, the load module 200 loads a design drawing of the product and a point cloud of the product after assembly into the storage system 12.

In step S402, the alignment module 210 aligns the point cloud of the product after assembly with the design drawing of the product. In this embodiment, the alignment module 210 may use the method of least squares to align the point cloud of the product after assembly with the design drawing of the product. A function of the method of least squares to align the point cloud of the product after assembly with the design drawing of the product may be:

$$f ( {X}^{′} ) = Min \sqrt{( {\sum }_{m = 1}^{m} {( \sqrt{{( X {2}^{′} - X {1}^{′} )}^{2} + {( Y {2}^{′} - Y {1}^{′} )}^{2} + {( Z {2}^{′} - Z {1}^{′} )}^{2}} )}^{2} ) \text{/} m} ,$$

where (X1′, Y1′, Z1′) are coordinates of a point in the design drawing of the product, (X2′, Y2′, Z2′) are coordinates of a point in the point cloud of the product after assembly.

In step S403, for each point in the point cloud of the product after assembly, the calculation module 220 calculates a nearest distance from the point in the point cloud of the product after assembly to a similar point in the design drawing of the product, and determines a range that the nearest distance falls within. In one example, a first range (e.g., less than or equal to 0.10 mm), a second range (e.g., greater than 0.10 mm and less than or equal to 0.20 mm), and a third range (e.g., greater than 0.20 mm) are predefined.

In step S404, the mark module 230 marks each point in the point cloud of the product, to indicate the range that the nearest distance from the point in the point cloud of the product to the similar point in the design drawing falls within. In one example, if the nearest distance from one point in the point cloud of the product after assembly to the similar point in the design drawing is less than or equal to 0.10 mm, the point is marked with green. If the nearest distance from one point in the point cloud of the product after assembly to the similar point in the design drawing is larger than 0.10 mm and less than or equal to 0.20 mm, the point is marked with yellow. If the nearest distance from one pint in the point cloud of the product after assembly to the similar point in the design drawing is more than 0.20 mm, the point is marked with red.

In step S405, the display module 240 displays the marked point cloud of the product after assembly on the display device 14.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method for analyzing assembly deformation of a product executed by a processor of a computing device, the method comprising:
loading a reference drawing of the product and an actual drawing of the product after assembly into a storage system of the computing device;
aligning the actual drawing with the reference drawing;
for each point in the actual drawing, calculating a nearest distance from the point in the actual drawing to a similar point in the reference drawing, and determining a range that the nearest distance falls within;
indicating the range that the nearest distance falls within by marking the point in the actual drawing; and
displaying the marked actual drawing on a display device connected to the computing device.

2. The method of claim 1, wherein the reference drawing of the product is a point cloud of a manufactured part of the product, and the actual drawing of the product after assembly is a point cloud of the manufactured part of the product after assembly.

3. The method of claim 2, further comprising:
generating a triangular mesh of the manufactured part according to the point cloud of the manufactured part of the product before assembly.

4. The method of claim 3, wherein the point cloud of the manufactured part of the product after assembly is aligned with the triangular mesh, and a nearest distance from each point in the point cloud of the manufactured part after assembly to the triangular mesh is calculated.

5. The method of claim 1, wherein the reference drawing of the product is a design drawing of the product, and the actual drawing of the product after assembly is a point cloud of the product after assembly.

6. A computing device, comprising:
at least one processor; and
a storage system storing a plurality of instructions, which when executed by the at least one processor, cause the at least one processor to:
load a reference drawing of a product and an actual drawing of the product after assembly into the storage system;
align the actual drawing with the reference drawing;
for each point in the actual drawing, calculate a nearest distance from the point in the actual drawing to a similar point in the reference drawing, and determine a range that the nearest distance falls within;
indicate the range that the nearest distance falls within by marking the point in the actual drawing; and
display the marked actual drawing on a display device connected to the computing device.

7. The computing device of claim 6, wherein the reference drawing of the product is a point cloud of a manufactured part of the product, and the actual drawing of the product after assembly is a point cloud of the manufactured part of the product after assembly.

8. The computing device of claim 7, wherein the instructions further cause the at least one processor to:
generate a triangular mesh of the manufactured part according to the point cloud of the manufactured part of the product before assembly.

9. The computing device of claim 8, wherein the point cloud of the manufactured part of the product after assembly is aligned with the triangular mesh, and a nearest distance from each point in the point cloud of the manufactured part after assembly to the triangular mesh is calculated.

10. The computing device of claim 6, wherein the reference drawing of the product is a design drawing of the product, and the actual drawing of the product after assembly is a point cloud of the product after assembly.

11. A non-transitory computer-readable storage medium storing a set of instructions, the set of instructions capable of being executed by a processor of a computing device to implement a method for analyzing assembly deformation of a product, the method comprising:
loading a reference drawing of the product and an actual drawing of the product after assembly into a storage system of the computing device;
aligning the actual drawing with the reference drawing;
for each point in the actual drawing, calculating a nearest distance from the point in the actual drawing to a similar point in the reference drawing, and determining a range that the nearest distance falls within;
indicating the range that the nearest distance falls within by marking the point in the actual drawing; and
displaying the marked actual drawing on a display device connected to the computing device.

12. The storage medium of claim 11, wherein the reference drawing of the product is a point cloud of a manufactured part of the product, and the actual drawing of the product after assembly is a point cloud of the manufactured part of the product after assembly.

13. The storage medium of claim 12, wherein the method further comprises:
generating a triangular mesh of the manufactured part according to the point cloud of the manufactured part of the product before assembly.

14. The storage medium of claim 13, wherein the point cloud of the manufactured part of the product after assembly is aligned with the triangular mesh, and a nearest distance from each point in the point cloud of the manufactured part after assembly to the triangular mesh is calculated.

15. The storage medium of claim 11, wherein the reference drawing of the product is a design drawing of the product, and the actual drawing of the product after assembly is a point cloud of the product after assembly.
